(19) United States
(12) Patent Application Publication
(10) Pub. No.: US 2022/0053918 A1
(43) Pub. Date: Feb. 24, 2022

(54) EDUCATIONAL HAIRSTYLING APPARATUS, SYSTEM, AND METHOD

(71) Applicant: Alex Ioannou, Chicago, IL (US)

(72) Inventor: Alex Ioannou, Chicago, IL (US)

(21) Appl. No.: 17/302,664

(22) Filed: May 10, 2021

Related U.S. Application Data
(60) Provisional application No. 62/706,533, filed on Aug. 24, 2020.

(51) Int. Cl. A45D 44/14; G09B 19/00

(52) U.S. Cl. CPC A45D 44/14; G09B 19/00

(57) ABSTRACT

A system and method for teaching an individual how to cut hair is disclosed. The system includes a head form that may have a plurality of dividing lines being formed on an outer profile of the head form. The plurality of dividing lines define distinct regions of the head form. The system also includes a plurality of skewers. In use, the skewers are inserted into the head form, with the skewers being a representation of hair, to illustrate various hair cutting techniques and styles.

### CROSS-REFERENCE TO RELATED APPLICATION

This application claims the benefit of priority of U.S. provisional application No. 62/706,533, filed Aug. 4, 2020, the contents of which are herein incorporated by reference.

### BACKGROUND OF THE INVENTION

The present invention relates to hairstyling/haircutting education and, more particularly, to a two-piece, three-dimensional (3D) education tool used to teach various techniques and styles of cutting and styling hair.

Education tools for hair cutting are conventionally a pen and paper process. This process, by its very nature, is two-dimensional (2D)/flat. Of course, an individual who cuts/styles someone else's hair will be doing so in a 3D environment and will not be working from a single direction/viewpoint (which is one limitation of a 2D teaching process).

Thus, using a 2D perspective for learning techniques and styles is wholly insufficient at providing an all-around perspective view to simulate an actual hair cutting environment. In the hairstyling market, while other teaching methods have been marketed, none provide the detail, description, and overall solution of the present invention.

As can be seen, there is a need for a two-piece, three-dimensional (3D) education tool used to teach various hair cutting and styling techniques.

### SUMMARY OF THE INVENTION

In one aspect of the present invention, a system for use in hair cutting education is disclosed, with the system comprising: a head form; and a plurality of skewers configured to be inserted into the head form, the plurality of skewers being a representation of hair when inserted into the head form.

In another aspect of the present invention, a method for providing hair cutting education is disclosed, with the method comprising the steps of: providing a head form; providing a plurality of skewers; and inserting the plurality of skewers into the head form, the plurality of skewers being a representation of hair.

These and other features, aspects and advantages of the present invention will become better understood with reference to the following drawings, description and claims.

### BRIEF DESCRIPTION OF THE DRAWINGS

FIG. 1 is a top plan view of a head form of an embodiment of the present invention;

FIG. 2 is a front perspective view of the head form of the embodiment of the present invention;

FIG. 3 is a side perspective view of the head form of the embodiment of the present invention;

FIG. 4 is a rear perspective view of the head form of the embodiment of the present invention.

FIG. 5 is a side elevation view of a set of skewers of the embodiment of the present invention;

FIG. 6 is a detail perspective view of a skewer of the set of skewers shown in FIG. 5;

FIG. 7 is a front perspective view of the embodiment of the present invention, in use with the set of skewers inserted into the head form; and

FIG. 8 is a side perspective view of the embodiment of the present invention, in use with the set of skewers inserted into the head form.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention disclose a system and method for teaching an individual how to cut hair. The system includes a head form that may have a plurality of dividing lines formed on (or drawn on) an outer profile of the head form. The plurality of dividing lines divides the head form into distinct regions. The system also includes a plurality of skewers. In use, the skewers are inserted into the head form to illustrate various hair cutting techniques, styles and hair lengths.

In accordance with certain aspects of the present invention, placement of skewers on top of a head form can be used to achieve various visual effects, such as: same, increase or decrease in hair length pertaining to a particular technique or haircut. Because of the head form's 3D configuration, a plurality of individuals (e.g., students) may see completely around and on top of the head form to better understand the techniques, hair length, weight distribution, balance, and shape. The present invention, as embodied, is an interactive, 3D process that allows the viewer to see and participate in all aspects of the learning process. Embodiments of the present invention allow users a better hands-on, interactive experience where they may place the skewers themselves and see the 3D effect all around the head form. Embodiments of the present invention, in comparison to the prior art, offers a better visual, resulting in a clearer understanding of the process.

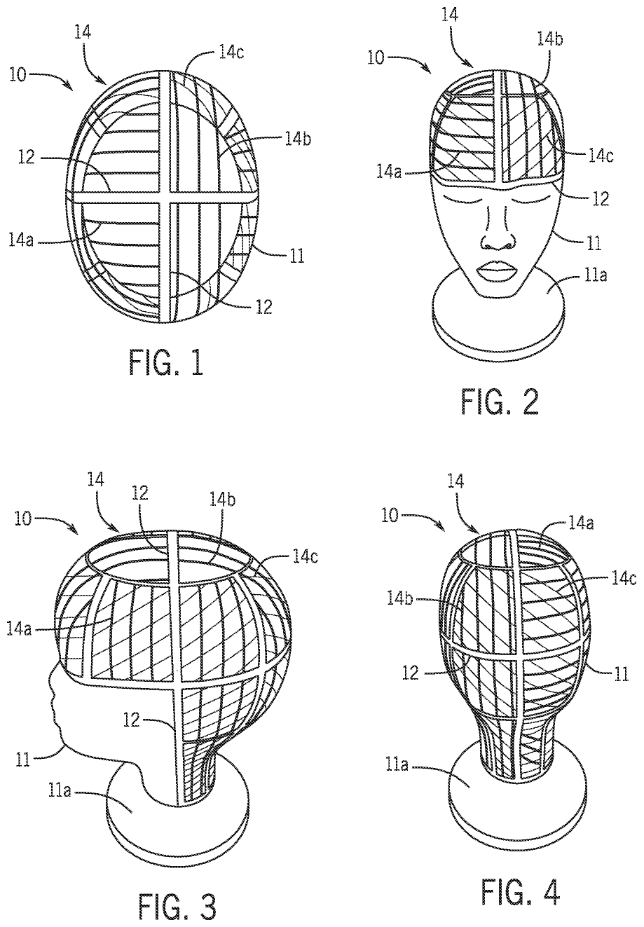

Referring now to FIGS. 1-4, a 3D haircutting education system 10 includes a head form 11 with a base 11a. The head form 11 further includes a plurality of printed on segment dividing lines 12. As can be seen, the dividing lines 12 divide the head form 11 into distinct regions to advantageously allow placement instructions for each technique or cut. In certain embodiments, the dividing lines 12 may be added by a user, rather than being pre-formed on the head form 11. In use, a user may draw on a plurality of guide lines 14 in the distinct regions of the head form 11. The guide lines 14 may be embodied as substantially horizontal guide lines 14a, substantially vertical guide lines 14b, substantially oblique guide lines 14c, and combinations thereof. The guide lines 14 may be formed using different colors, which are representative of varying techniques or method of cuts (in combination with the orientation/placement of the guide lines 14).

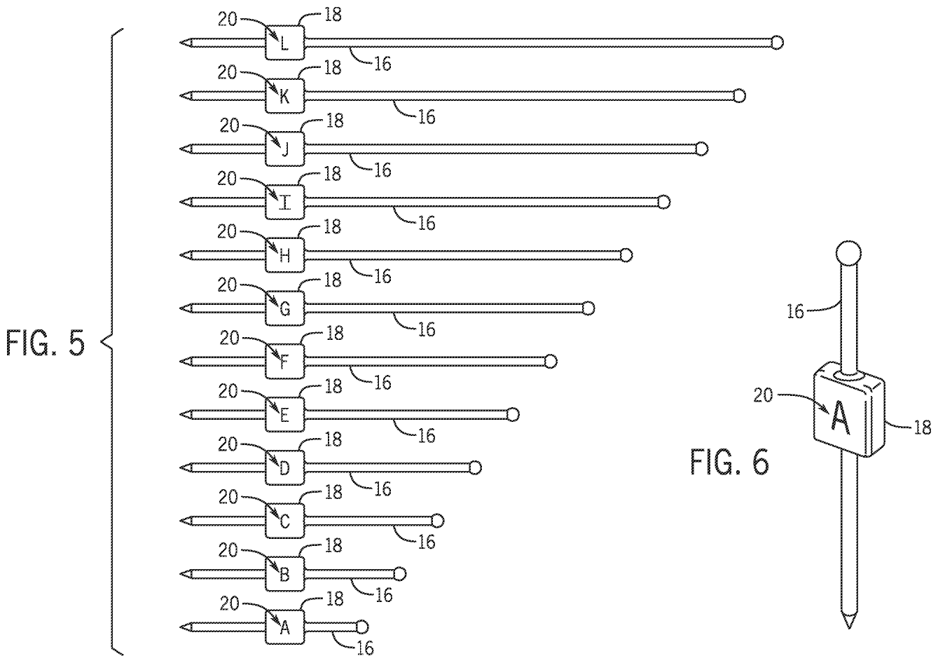

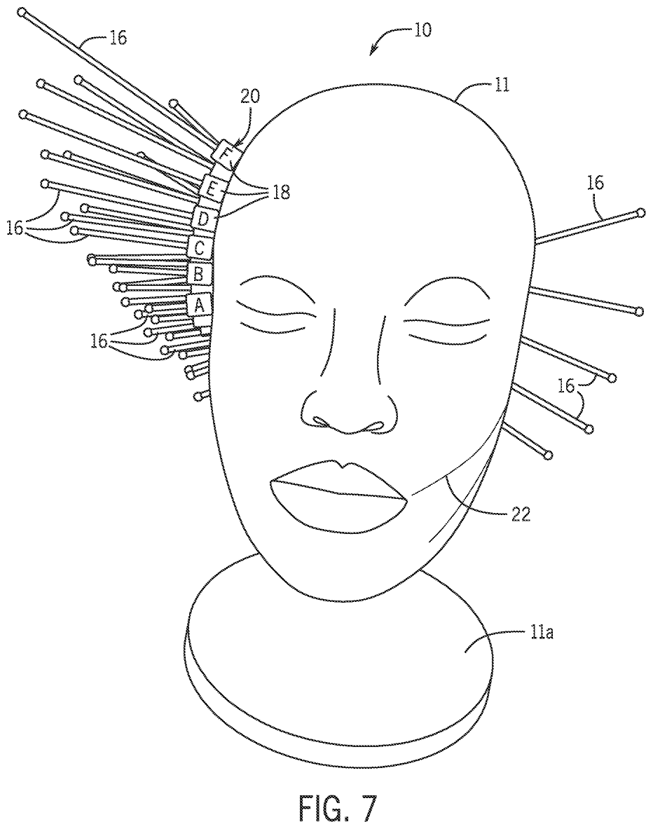

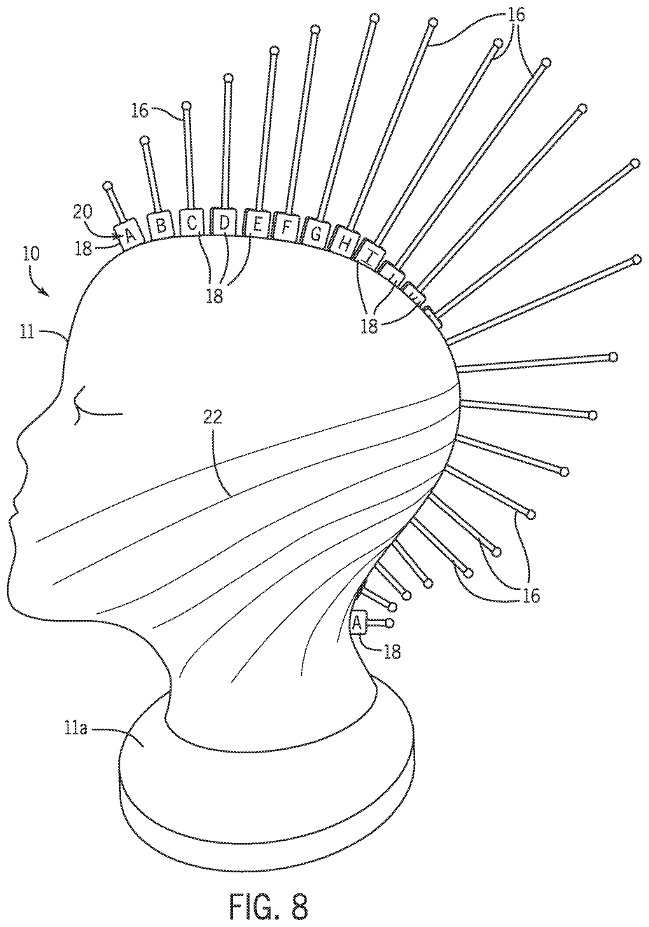

Referring now to FIGS. 5-6, a set/plurality of skewers 16 are provided as part of the 3D haircutting system 10. The term “skewer”, as used herein, denotes a long piece of material (such as wood, metal, or plastic) which may, in certain embodiments, have a pointed end. Depending on the shape and/or technique of the cut being taught and learned, the head form 11, which includes the pre-formed dividing lines 12 and user-added guide lines 14, allows a user to insert a plurality of the skewers 16 at strategic locations (within the distinct regions discussed above and on/along guide lines 14) to demonstrate a particular technique or cut. In certain embodiments, the skewers 16 may come in half an inch increments, although other size increments (e.g., ¼-inch increments) and number of skewers of a particular size, depending on the technique shown, (e.g., three 6-inch skewers may be provided in a set) are in accordance with the present invention. Further, each skewer 16 includes a stopper block 18 to serve as a stop from further insertion of the respective skewer 16 into the head form 11 (see FIGS. 7-8). Each stopper block includes an indicia 20, which may be a number (such as the length of the skewer), color, or a letter for example, to better delineate between the varying length skewers.

As shown, for example, in FIGS. 7-8, in use, the placement of the skewers 16 may be done so to denote increasing or decreasing hair lengths within the technique or haircut at certain points of the head form 11. Reference number 22 denotes another configuration of contour/guide lines that a user may draw on the head form 11. The dividing lines 12 are omitted from view in FIGS. 7 and 8 as these Figures are only intended to show potential configuration/placements of the skewers 16 on the head form 22. The skewers 16 may be placed strategically in the head form 10, following step by step instructions (such as from a manual or printed instructions as part of the overall system 10) describing the technique and hair cut associated with the different skewer 16 lengths.

Much like interlocking plastic brick pieces, the different length skewers 16 may be placed randomly on the head form 11 or in any number of configurations dictated by the guide lines 14, creating different shapes, and offering a 3D view of the potential finished result (e.g., FIGS. 7 and 8). The potential finished result highlights shape, weight distribution, length and balance. In unison with a demonstration of a haircut, adding skewers 16 to the head form 11 will show what the hair would look like if sticking straight out from the head to demonstrate varying lengths. The present invention also allows the audience a 360-degree view all around the head.

To make an embodiment of the present invention, and as mentioned above, the skewers 16 may be formed from either metal, plastic or wood. One end of each skewer 16 may be pointed with approximately 1-inch in length from the stopper 18 to the tip of the point. The skewers 16 vary in length from the stopper up to a terminal end opposite the pointed end, starting at ½-inch and increasing ½-inch increments until a desired maximum length is reached. In certain embodiments of the present invention, all inch size measurement skewers 16 (e.g., 1-inch, 2-inch, etc.) may be one color from stopper down and all skewers that measure a ½ inch increment (e.g., 1.5-inch, 2.5-inch, etc.) may be another color. However, it will be appreciated that color coding the stopper and point is optional. Other lengths of skewers 16 may be provided/formed, as appropriate. For example, some or all of the skewers 16 may be equal in length depending upon the haircut style/technique being taught. The head form 11 may be formed from, for example, closed-cell extruded polystyrene foam such that it may facilitate insertion of the skewers.

Further, the head form, as described, may have dividing lines drawn, printed, taped, or painted on it in the following manner. Dividing lines 12 for points of balance that divide the head form 11 may be embodied, for example, as follows. A first horizontal line is provided to encircle the entire head form 11, sitting at the top of the ears, top of eyes and the back of the head, where the head form 11 starts to round into the crown. A second horizontal line (line 12 shown in FIG. 3) is provided from ear to ear, across the top of the head form 11, intersecting the top round of the head form 11. A vertical line is provided from middle front of the head form 11, between the eyes region, typically following the line of the nose to the lower back of the head form 11, ending at the nape (which is proximal the base 11a; see for example FIG. 4). A rectangle or oval shape is provided that is at the top rounding of the head form 11. The corners of said rectangle or oval sit between the two original dividing lines (the second horizontal and vertical lines mentioned above). Four vertical lines are provided, starting at the top rectangle shape, going down into the hairline at the vertical round of the head. Another, third horizontal line is provided from bottom of ear (i.e., where an ear would typically be disposed on a head if the head form 11 does not include an ear shape) to opposite bottom of ear, across the back of the head, at the occipital bone.

It should be understood, of course, that the foregoing relates to exemplary embodiments of the invention and that modifications may be made without departing from the spirit and scope of the invention as set forth in the following claims.

In the following claims, any labelling of elements, limitations, steps, or other parts of a claim (for example, first, second, etc., (a), (b), (c), etc., or (i), (ii), (iii), etc.) is only for purposes of clarity, and are not to be interpreted as suggesting any sort of ordering or precedence of the claim parts so labelled. If any such ordering or precedence is intended, it will be explicitly recited in the claim or, in some instances, it will be implicit or inherent based on the specific content of the claim. To further aid the USPTO and any readers of any patent issued on this application, it is additionally noted that there is no intent any of the appended claims to invoke paragraph (f) of 35 U.S.C. § 112 as it exists on the date of filing hereof unless the words “means for” or “step for” are explicitly used in the particular claim.

What is claimed is:

1. A system for use in hair cutting education, the system comprising:
a head form; and
a plurality of skewers configured to be inserted into the head form, the plurality of skewers being a representation of hair when inserted into the head form.

2. The system of claim 1, further comprising a plurality of dividing lines being formed on an outer profile of the head form, the plurality of dividing lines defining distinct regions of the head form.

3. The system of claim 2, wherein the plurality of dividing lines comprises a first horizontal dividing line that extends around a horizontal circumference of the head form.

4. The system of claim 3, wherein the plurality of dividing lines further comprises a first vertical dividing line that extends from a middle front portion of the head form, the middle front portion being proximal an eye region of the head form, and the first vertical dividing line terminates proximal a base of the head form.

5. The system of claim 4, wherein the plurality of dividing lines further comprises a second horizontal dividing line that:
extends from a first lateral side of the base of the head form;
intersects the first horizontal dividing line at two points, the two points generally denoting ear regions of the head form; and
terminates at a second lateral side of the base of the head form.

6. The system of claim 1, wherein each of the plurality of skewers further comprises a stopper block positioned on the skewer, the stopper block being configured to prevent insertion of the skewer into the head form beyond a predetermined length.

7. The system of claim 6, wherein each stopper block has an indicia formed on a face of the stopper block.

8. The system of claim 6, wherein each of the plurality of skewers has a pointed end, and, for each of the plurality of skewers, the stopper block is positioned approximately one inch from the pointed end.

9. The system of claim 1, wherein each of the plurality of skewers have a length different from other skewers of the plurality of skewers.

10. The system of claim 1, wherein the head form comprises a closed-cell extruded polystyrene foam material.

11. A method for providing hair cutting education, the method comprising the steps of:
providing a head form;
providing a plurality of skewers; and
inserting the plurality of skewers into the head form, the plurality of skewers being a representation of hair.

12. The method of claim 11, further comprising the step of: forming a plurality of dividing lines on an outer profile of the head form, the plurality of dividing lines defining distinct regions of the head form.

13. The method of claim 12, wherein, prior to the inserting the plurality of skewers into the head form step, the method further comprises the step of:
drawing a plurality of guide lines on the head form on at least one of the distinct regions.

14. The method of claim 13, wherein the inserting the plurality of skewers into the head form step comprises: inserting the plurality of skewers into the head form along the plurality of guide lines on the head form.
